(19) United States
(12) Patent Application Publication
(10) Pub. No.: US 2021/0327619 A1
(43) Pub. Date: Oct. 21, 2021

(54) MAGNETIC NANOSTRUCTURES COMPRISING COPPER AND PREPARATION METHOD OF SAME

(71) Applicant: INDUSTRY-UNIVERSITY COOPERATION FOUNDATION HANYANG UNIVERSITY ERICA CAMPUS, Ansan-Si, Gyeonggi-do (KR)

(72) Inventors: Yong-Ho Choa, Seongnam-si (KR); Jongryoul Kim, Seoul (KR); Jimim Lee, Seoul (KR); Tae-Yeon Hwang, Ansan-si (KR); Min Kyu Kang, Daegu (KR); Gyutae Lee, Seoul (KR)

(73) Assignee: INDUSTRY-UNIVERSITY COOPERATION FOUNDATION HANYANG UNIVERSITY ERICA CAMPUS, Ansan-Si, Gyeonggi-do (KR)

(21) Appl. No.: 17/260,605

(22) PCT Filed: Jan. 31, 2019
(86) PCT No.: PCT/KR2019/001366

§ 371 Date: Jan. 15, 2021

(30) Foreign Application Priority Data
Nov. 28, 2018 (KR) 10-2018-0149439
Jan. 30, 2019 (KR) 10-2019-0011808

(51) Int. Cl. H01F 1/055; D01D 5/00

(52) U.S. Cl. CPC H01F 1/055; B82Y 25/00; D01D 5/0007

(57) ABSTRACT

Provided is a preparation method of magnetic nanostructures. The preparation method of magnetic nanostructures may comprise the steps of: preparing a source solution comprising a first precursor comprising a rare earth element, a second precursor comprising a transition metal element, and a third precursor comprising Cu; electrospinning the source solution to form preliminary magnetic nano-structures comprising a rare-earth element oxide, a transition metal oxide, and Cu oxide; and reducing the preliminary magnetic nano-structures to produce magnetic nano-structures comprising an alloy composition comprising the rare-earth element, the transition metal element, and the Cu.

### TECHNICAL FIELD

The present invention relates to a magnetic nano-structure containing copper and a method for preparing the same, and more particularly, to a magnetic nano-structure containing copper and a method for preparing the same, from a source solution containing a rare-earth element.

### BACKGROUND ART

Hard magnetic permanent magnets have been used indispensably for electric devices such as motors, speakers, and measuring instruments, as well as small motors in hybrid vehicles (HEVs) and electric vehicles (EVs). R₂Fe₁₄B series, R₂Fe₁₇Nx series and R₂TM₁₇ series (R: rare-earth element, TM: transition metal element) having high coercive force are widely used as a material for the above magnets. Unlike the former two series, the R₂TM₁₇ series has an advantage in an aspect of phase formation and chemical stability because the R₂TM₁₇ series is not easily pyrolyzed and has a high Curie temperature.

Recently, as electronic products have a lighter weight, miniaturized size and higher performance, a permanent magnet material having a more improved maximum magnetic energy product ((BH)ₘₐₓ) is required. However, because each material has a critical point of magnetic properties, researches for overcoming the critical point have been conducted.

For example, Korean Unexamined Patent Publication No. 10-2017-0108468 (Application No. 10-2016-0032417. Applicant: Yonsei University Industry-Academic Cooperation Foundation) discloses a non-rare-earth permanent magnet having an improved coercive force and including a substrate; and a thin film laminate formed on the substrate and obtained by repeatedly laminating and heat-treating a lamination unit, which is composed of a Bi thin film layer and an Mn thin film layer, at least two times or more, and a method for preparing the same.

### DISCLOSURE

### Technical Problem

One technical problem to be solved by the present invention is to provide a magnetic nano-structure containing copper (Cu) and a method for preparing the same to have improved magnetic properties.

Another technical problem to be solved by the present invention is to provide a magnetic nano-structure containing copper (Cu) and a method for preparing the same to improve magnetic properties through a simple process.

Still another technical problem to be solved by the present invention is to provide a magnetic nano-structure containing copper (Cu) and a method for preparing the same to reduce economic costs.

The technical problems to be solved by the present invention are not limited to the above descriptions.

### Technical Solution

In order to solve the above technical problems, the present invention provides a method for preparing a magnetic nano-structure.

According to one embodiment, the method for preparing the magnetic nano-structure preparing a source solution containing a first precursor including a rare-earth element, a second precursor including a transition metal element, and a third precursor including Cu; electrospinning the source solution to form a preliminary magnetic nano-structure containing a rare-earth oxide, a transition metal oxide, and Cu oxide; and reducing the preliminary magnetic wire to manufacture a magnetic nano-structure containing an alloy composition of the rare-earth element, the transition metal element, and the Cu.

According to one embodiment, a molar ration of the Cu in the source solution may be more than 5.8 at % and less than 10.9 at %.

According to one embodiment, the step of forming the magnetic nano-structure may include mixing the preliminary magnetic nano-structure with a reducing agent, heat-treating the preliminary magnetic nano-structure mixed with the reducing agent, and washing the heat-treated preliminary magnetic nano-structure by using a cleaning solution.

According to one embodiment, the reducing agent may include calcium (Ca).

According to one embodiment, the method for preparing the magnetic nano-structure may include controlling a coercive force by controlling a content of Cu.

In order to solve the above technical problems, the present invention provides a magnetic nano-structure.

According to one embodiment, the magnetic nano-structure includes an alloy composition of a rare-earth element, a transition metal element, and Cu, and Cu in the alloy composition may have a content more than 5.8 wt % and less than 10.0 wt %.

According to one embodiment, the alloy composition may be composed of a unit lattice (unit cell) represented by ReM₅ (Re is a rare-earth element, and M is at least one of a transition metal element or Cu).

According to one embodiment, a crystal structure of ReM₅ may include a hexagonal system.

According to one embodiment, Cu may be disposed in at least one of 2c and 2g sites in the unit lattice.

According to one embodiment, the rare-earth element may include any one of La, Ce, Pr, Nd, Sm, or Gd.

According to one embodiment, the transition metal element may include any one of Co or Ni.

According to one embodiment, the magnetic nano-structure may have a single crystal and an anisotropic property.

According to one embodiment, in the alloy composition a content of the rare-earth element may be 16.7 wt %, and the content of the transition metal element may be more than 73.2 wt % and less than 77.5 wt %.

According to another embodiment, the magnetic nano-structure may include an alloy composition composed of a unit lattice represented by <Formula 1>.

ReTMₓCu₅₋ₓ <Formula 1>

(Re: rare-earth element, TM: transition metal element)

According to another embodiment, the magnetic nano-structure may include an alloy composition having a unit lattice represented by <Formula 1> after more than 7% and less than 12% of the TM is substituted with the Cu in the alloy composition composed of a unit lattice represented by the following <Formula 2>.

ReTM₅ <Formula 2>

(Re: rare-earth element, TM: transition metal element)

According to another embodiment, the magnetic nano-structure may have a coercive force of 40000 Oe or more.

The method for preparing a magnetic nano-structure according to the embodiments of the present invention includes: preparing a source solution containing a first precursor including a rare-earth element, a second precursor including a transition metal element, and a third precursor including Cu; forming a preliminary magnetic nano-structure containing a rare-earth oxide, a transition metal oxide, and Cu oxide by electrospinning the source solution; and preparing a magnetic nano-structure containing an alloy composition of the rare-earth element, the transition metal element, and the Cu by reducing the preliminary magnetic micro-structure.

### Advantageous Effects

In other words, the method for preparing a magnetic nano-structure according to the embodiment may have a bottom-up approaching properties.

When a magnetic nano-structure is prepared through the preparing method with the above bottom-up approach properties, the Cu content in the magnetic nano-structure, which is the finally generated material, can be controlled by a simple method of controlling the content of the third precursor in the step of preparing the source solution. When the Cu content in the magnetic nano-structure is controlled to be greater than 5.8 wt % and less than 10.0 wt %, or when more than 7% and less than 12% of the TM is substituted with the Cu in the alloy composition composed of a unit lattice represented by the above <Formula 2> so as to have a unit lattice represented by the above <Formula 1>, the coercive force of the magnetic nano-structure can be improved. As a result, the magnetic nano-structure having improved magnetic properties can be provided. In addition, copper is used instead of expensive cobalt, so that the magnetic nano-structure reduced in economic costs can be provided.

### DESCRIPTION OF DRAWINGS

FIG. 1 is a flow chart illustrating a method for preparing a magnetic nano-structure according to the embodiment of the present invention.

FIG. 2 is a flow chart specifically illustrating a step of forming a magnetic nano-structure in the method for preparing the magnetic nano-structure according to the embodiment of the present invention.

FIG. 3 is a view showing a preparing process of the magnetic nano-structure according to the embodiment of the present invention.

FIG. 4 is a view showing a unit lattice represented by SmCo₅ to illustrate a structure of the magnetic nano-structure according to the embodiment of the present invention.

FIGS. 5 to 9 are photographs of magnetic nano-structures according to Examples and Comparative Example 1 of the present invention.

FIG. 10 is a graph showing X-ray diffraction analysis of an Sm—Co alloy composition and an Sm—Co—Cu alloy composition.

FIG. 11 is a graph showing X-ray diffraction analysis of magnetic nano-structures according to Examples and Comparative Example 1 of the present invention.

FIGS. 12 and 13 are X-ray diffraction analysis graphs for analyzing structures of magnetic nano-structures according to Examples and Comparative Example 1 of the present invention.

FIG. 14 is a graph showing the magnetization characteristics of magnetic nano-structures according to Examples and Comparative Example of the present invention.

FIG. 15 is a graph for comparing coercive forces of the magnetic nano-structures according to Examples and Comparative Examples of the present invention.

### BEST MODE

### Mode for Invention

Hereinafter, exemplary embodiments of the present invention will be described in detail with reference to the accompanying drawings. However, the technical idea of the present invention is not limited to the exemplary embodiments described herein and may be embodied in other forms. Further, the embodiments disclosed thoroughly and completely herein may be provided such that the idea of the present invention can be fully understood by those skilled in the art.

In the specification, when one component is mentioned as being on another component, it signifies that the one component may be placed directly on another component or a third component may be interposed therebetween. In addition, in drawings, thicknesses of films and regions may be exaggerated to effectively describe the technology of the present invention.

In addition, although the terms such as first, second and third are used to describe various components in various embodiments of the present specification, the components should not be limited by the above terms. The above terms are used merely to distinguish one component from another. Accordingly, a first component referred to in one embodiment may be referred to as a second component in another embodiment. Each embodiment described and illustrated herein may also include a complementary embodiment. In addition, the term “and/or” is used herein to include at least one of the components listed before and after the term.

The singular expression herein includes a plural expression unless the context clearly specifies otherwise. In addition, it should be understood that the term such as “include” or “have” herein is intended to designate the presence of feature, number, step, component, or a combination thereof recited in the specification, and does not preclude the possibility of the presence or addition of one or more other features, numbers, steps, components, or combinations thereof. In addition, the term “connection” is used herein to include both indirectly connecting a plurality of components and directly connecting the components.

In addition, in the following description of the embodiments of the present invention, the detailed description of known functions and configurations incorporated herein will be omitted when it possibly makes the subject matter of the present invention unclear unnecessarily.

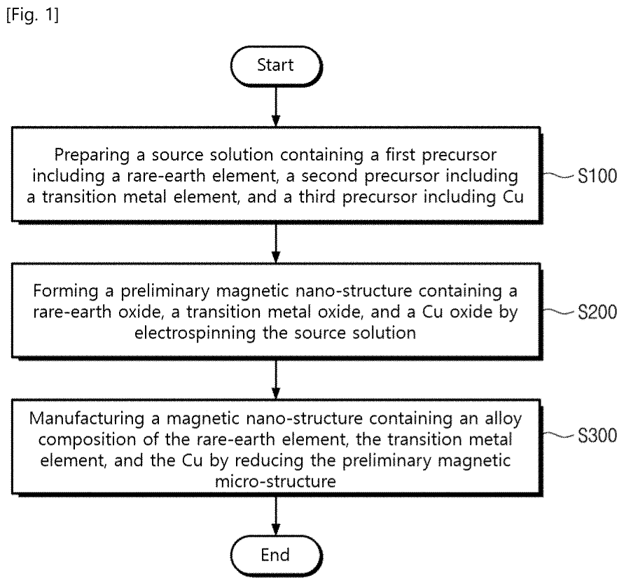

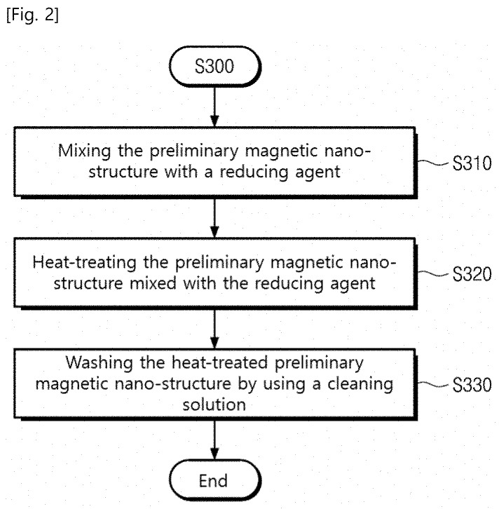

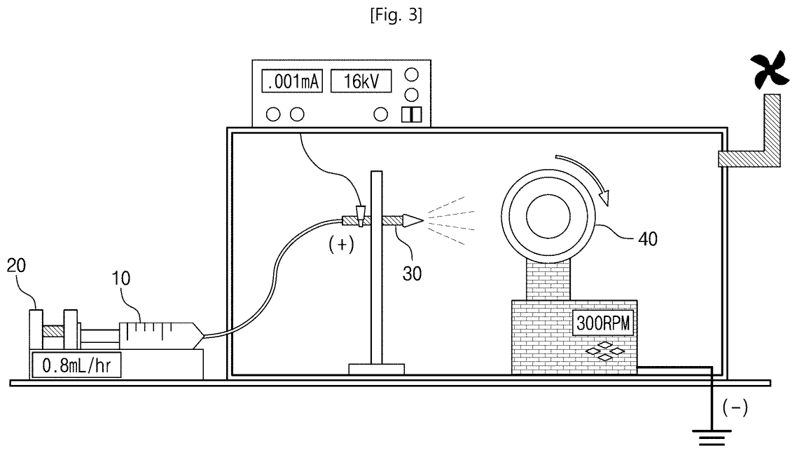

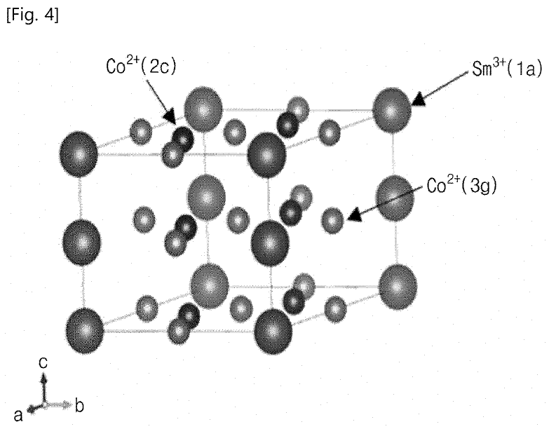

FIG. 1 is a flow chart illustrating a method for preparing a magnetic nano-structure according to the embodiment of the present invention. FIG. 2 is a flow chart specifically illustrating a step of forming a magnetic nano-structure in the method for preparing the magnetic nano-structure according to the embodiment of the present invention. FIG. 3 is a view showing a preparing process of the magnetic nano-structure according to the embodiment of the present invention. FIG. 4 is a view showing a unit lattice represented by SmCo₅ to illustrate a structure of the magnetic nano-structure according to the embodiment of the present invention.

Referring to FIGS. 1 to 3, a source solution including a first precursor, a second precursor, and a third precursor may be prepared (S100). According to one embodiment, the first precursor may include a rare-earth element. For example, the rare-earth element may include any one of La, Ce, Pr, Nd, Sm, or Gd. According to one embodiment, the second precursor may include a transition metal element. For example, the transition metal element may include any one of Co or Ni. According to one embodiment, the third precursor may include Cu.

The source solution may further include a viscous source. According to one embodiment, the viscous source may include polymer. For example, the polymer may include at least one of polyvinylpyrrolidone (PVP), polyacrylonitrile (PAN), polyvinyl acetate (PVAC), polyvinylbutyral (PVB), polyvinyl alcohol (PVA), or polyethylene oxide (PEO). The viscous source may provide viscosity to the source solution, so that a diameter of the magnetic nano-structure described later may be controlled.

According to one embodiment, a molar fraction (at %) of the third precursor in the source solution may be controlled. Specifically, a molar ratio of Cu in the source solution may be controlled to be greater than 5.8 at % and less than 10.0 at %. In this case, the magnetic nano-structure described later may have a unit lattice represented by the above <Formula 1> after more than 7% and less than 12% of the TM is substituted with the Cu in the alloy composition composed of a unit lattice represented by the following <Formula 2>. Accordingly, the maximum magnetic energy product value ((BH)ₘₐₓ) of the magnetic nano-structure may be improved. More details will be described later.

ReTMₓCu₅₋ₓ <Formula 1>

(Re: rare-earth element, TM: transition metal element)

ReTM₅ <Formula 2>

(Re: rare-earth element, TM: transition metal element)

The source solution may be electrospun to form a preliminary magnetic nano-structure (S200). The preliminary magnetic nano-structure formed by electrospinning the source solution may include rare-earth oxide, transition metal oxide, and Cu oxide.

According to one embodiment, the step of forming the preliminary hybrid magnetic fiber may include forming a first preliminary hybrid magnetic fiber, and forming a second preliminary hybrid magnetic fiber. The step of forming the first preliminary hybrid magnetic fiber may be performed by electrospinning the source solution. The first preliminary hybrid magnetic fiber may be formed of solid components of the source solution. The first preliminary hybrid magnetic fiber may include water-soluble metallic salt, polymer, and the like. The step of forming the second preliminary hybrid magnetic fiber may be performed by calcining the first preliminary hybrid magnetic fiber. In other words, the step may be performed by heat-treating the first preliminary hybrid magnetic fiber and decomposing organic materials including polymer in the first preliminary hybrid magnetic fiber. The second preliminary hybrid magnetic fiber may include rare-earth oxide, transition metal oxide, and Cu oxide.

More specifically, after the source solution is injected into a syringe 10, the source solution may be spun using a syringe pump 20. In this case, a tip 30 of the syringe may have a diameter of 0.05 mm to 2 mm, the syringe tip 30 and a collector 40 for collecting the preliminary hybrid magnetic fiber may be spaced apart from each other by 10 cm to 20 cm, and the syringe pump 20 may spin the source solution at a rate of 0.3 mL/h to 0.8 mL/h. In addition, a voltage applied for electrospinning may be 16 kV to 23 kV. The first preliminary hybrid magnetic fiber may be formed through the above-described process.

The first preliminary hybrid magnetic fiber may be collected in an alumina crucible and heat-treated at an atmospheric pressure, that is, an atmospheric atmosphere of 500° C. to 900° C. In the above process, the organic materials including polymer may be entirely pyrolyzed. At this point, a heating rate condition may be 1° C. to 10° C. per minute. The second preliminary hybrid magnetic fiber may be formed through the above-described process.

The preliminary magnetic nano-structure may be reduced to form a magnetic nano-structure (S300). The magnetic nano-structure may include an alloy composition of a rare-earth element, a transition metal element, and Cu. In addition, the magnetic nano-structure may be an alloy composition composed of a unit lattice represented by following <Formula 1>. More specifically, the magnetic nano-structure may include 15 wt % to 18 wt % of the rare-earth element, 70 wt % to 79 wt % of the transition metal element, and 5.5 wt % to 10.5 wt % of the Cu. In addition, as being formed by the electrospinning as described above, the magnetic nano-structure may have a wire shape or a fiber shape.

ReTMₓCu₅₋ₓ <Formula 1>

(Re: rare-earth element, TM: transition metal element)

According to one embodiment, the magnetic nano-structure may have a crystal structure. For example, the magnetic nano-structure may have a single crystal. When the magnetic nano-structure has a crystal structure, the magnetic nano-structure may be composed of a unit lattice (unit cell) represented by ReM₅ (Re is a rare-earth element, and M is at least one of a transition metal element or Cu). The crystal structure of ReM₅ may be a hexagonal system.

The arrangement of atoms in the unit lattice represented by ReM₅ may be the same as the arrangement of atoms in the unit lattice represented by SmCo₅. In other words, the arrangement of Re (rare-earth element) in the unit lattice represented by ReM₅ may be the same as the arrangement of Sm in the unit lattice represented by SmCo₅. In addition, the arrangement of M (at least one of a transition metal element or Cu) in the unit lattice represented by ReM₅ may be the same as the arrangement of Co in a unit lattice represented by SmCo₅.

For further specific description, FIG. 4 shows the unit lattice represented by SmCo₅. As shown in FIG. 4, Co in the unit lattice represented by SmCo₅ may be disposed in at least one of 2c and 2g sites. Accordingly, M in the unit lattice represented by ReM₅ may also be disposed in at least one of 2c and 2g sites. In other words, the transition metal element or Cu may be disposed in 2c and 2g sites of the unit lattice represented by ReM₅.

When the Cu content increases, the magnetic nano-structure according to the embodiment may have decreased saturation magnetization value and remnant magnetization value, and increased rectangularity ratio (squareness) and coercive force. However, rates of the increased rectangularity ratio and coercive force may be greater than rates of the decreased saturation magnetization value and remnant magnetization value. Accordingly, when the Cu content increases, the maximum magnetic energy product value ((BH)ₘₐₓ) expressed by the product of the saturation magnetization value and the coercive force may increase.

However, when the Cu content exceeds a predetermined criterion, there may be a problem that the coercive force remarkably decreases. More specifically, when the Cu content exceeds the predetermined criterion, an atomic radius of Cu (1.57 Å) is smaller than an atomic radius of the transition metal (for example, 1.67 Å in the case of Co), so that a stable SmCu₅ phase at an energy-level may be easily formed. Accordingly, the magnetic nano-structure according to the embodiment may represent a form of a composite phase of ReM₅ and ReCu5 other than a form of the above-described ReM₅ single phase. In the case of ReM₅ single phase, an anisotropy and a high coercive force may be exhibited, however, when a plurality of phases are mixed, an isotropy may be exhibited, so a low coercive force may be exhibited.

As a result, the Cu content in the magnetic nano-structure according to the embodiment may be controlled to obtain a high maximum magnetic energy product value. According to one embodiment, the Cu content in the magnetic nano-structure may be controlled to be greater than 5.8 wt % and less than 10.0 wt %. In addition, the magnetic nano-structure may include an alloy composition having a unit lattice represented by the above <Formula 1> after more than 7% and less than 12% of the TM is substituted with the Cu in the alloy composition composed of a unit lattice represented by the following <Formula 2>.

ReTM₅ <Formula 2>

(Re: rare-earth element, TM: transition metal element)

In other words, when a substitution amount of Cu substituting the TM is controlled to be greater than 7% and less than 12% in the magnetic nano-structure, the Cu content in the magnetic nano-structure may be greater than 5.8 wt % and less than 10.0 wt %. When the content of Cu is controlled as described above, the magnetic nano-structure may exhibit an ReM₅ single phase and exhibit a high coercive force of 40000 Oe or more.

Unlike the above description, when the substitution amount of Cu in the magnetic structure is 7% or less or 12% or more, there may be a problem that the coercive force and the maximum magnetic energy product value decrease. In particular, when the substitution amount of Cu in the magnetic structure is less than 5%, the magnetic structure may exhibit a structure formed by mixing an Re₂M₁₇ phase, an Re₂M₇ phase, and an ReM₅ phase, so that the coercive force may be deteriorated. In addition, when the substitution amount of Cu in the magnetic structure is 20% or more, the magnetic structure may exhibit a structure formed by mixing an ReM₅ phase and an ReCu₅ phase, so that there may be a problem that the coercive force decreases.

According to one embodiment, when the Cu content in the magnetic nano-structure increases, a size of a crystal included in the magnetic nano-structure may increase. In other words, when the Cu content in the magnetic nano-structure increases, the degree of crystallinity of the magnetic nano-structure may be improved. As a result, the Cu may exert an effect on improving the crystallinity of the magnetic nano-structure.

According to one embodiment, the step of forming the magnetic nano-structure (S300) may include mixing the preliminary magnetic nano-structure with a reducing agent (S310), heat-treating the preliminary magnetic nano-structure mixed with the reducing agent (S320), and washing the heat-treated preliminary magnetic nano-structure by using a cleaning solution (S330). In other words, the preliminary magnetic nano-structure is mixed with the reducing agent and heat-treated, so that the magnetic nano-structure may be formed.

The reducing agent may include calcium (Ca). For example, the reducing agent may include CaH2. In this case, the magnetic nano-structure may be easily formed. Specifically, since the rare-earth elements have very little oxidation energy, the most stable phase may be maintained during an oxide form. Accordingly, since a high temperature of 1500° C. or higher and a hydrogen atmosphere are required to reduce the rare-earth oxide to metal, there may be difficulties in process. However, since calcium (Ca) has smaller oxidation energy compared to the rare-earth elements, the rare-earth oxide may be easily reduced to metal in a relatively low heat-treatment temperature (for example, 500° C. to 800° C.) and a non-hydrogen atmosphere when calcium is used as a reducing agent.

The washing solution may include at least one of ammonium chloride (NH₄Cl) and methanol (CH₃OH). In this case, the magnetic nano-structure may be easily formed.

Specifically, when the preliminary magnetic nano-structure is reduced using a reducing agent containing calcium (Ca), calcium oxide (CaO) may be formed on a surface of metal from which the rare-earth oxide is reduced. Accordingly, a process of removing calcium oxide (CaO) is required. The existing process of removing calcium oxide (CaO) uses a washing solution in which acetic acid or hydrochloric acid is mixed with ultrapure water. In this case, the acid solution may cause a fatal effect such as corrosion and oxidation even on the magnetic phase. However, a washing solution containing at least one of ammonium chloride (NH₄Cl) and methanol (CH₃OH) may easily remove calcium oxide (CaO) without affecting the magnetic phase.

The conventional methods of preparing a rare-earth permanent magnet include powder metallurgy scheme such as melt casting, extrusion molding or injection molding of ingots, and those are characterized by a top-down approach. When a substitution type alloy is prepared through the top-down approach, a complex microstructure of grain-grain boundary other than a single crystal shape may be easily formed, and an isotropic alloy may be obtained while generating numerous grains. The above isotropic alloy may consequently lower the coercive force, thereby causing deterioration of magnetic properties. In addition, since defects and impurities may be easily generated at the grain boundaries, and grains and grain boundaries may be easily formed in different phases, a behavior of a binary-phase separated from a magnetic hysteresis curve may be exhibited, and an adverse effect may be exerted on the magnetic properties.

However, the method for preparing a magnetic nano-structure according to the embodiments of the present invention may include preparing a source solution containing a first precursor including a rare-earth element, a second precursor including a transition metal element, and a third precursor including Cu; electrospinning the source solution to form a preliminary magnetic nano-structure containing a rare-earth oxide, a transition metal oxide, and Cu oxide; and reducing the preliminary magnetic micro-structure to manufacture a magnetic nano-structure containing an alloy composition of the rare-earth element, the transition metal element, and the Cu. In other words, the method for preparing a magnetic nano-structure according to the embodiment may have a bottom-up approaching properties.

When a magnetic nano-structure is prepared through the preparing method with the above bottom-up approaching properties, the Cu content in the magnetic nano-structure, which is the finally generated material, may be controlled by a simple method of controlling the content of the third precursor in the step of preparing the source solution. As described above, when the Cu content in the magnetic nano-structure is controlled to be greater than 5.8 wt % and less than 10.0 wt %, or when more than 7% and less than 12% of the TM is substituted with the Cu in the alloy composition composed of a unit lattice represented by the above <Formula 2> so as to have a unit lattice represented by the above <Formula 1>, the coercive force of the magnetic nano-structure may be improved. As a result, the magnetic nano-structure having improved magnetic properties may be provided. In addition, copper is used instead of expensive cobalt, so that the magnetic nano-structure reduced in economic costs may be provided.

The magnetic nano-structure and the method for preparing the same according to the embodiments of the present invention have been described. Hereinafter, results on specific experimental examples and characteristic evaluations will be described with respect to the magnetic nano-structure and the method for preparing the same according to the embodiments of the present invention.

### Preparing a Magnetic Nano-Structure According to Example 1

The source solution was prepared by mixing samarium (III) nitrate hexahydrate (Sm(NO₃)₃6H₂O), cobalt (II) nitrate hexahydrate (Co(NO₃)₂6H₂O), copper nitrate trihydrate (Cu(NO₃)₂3H₂O), and PVP having a concentration of 3 wt % with 7 mL of ultrapure water.

The prepared source solution was placed in a syringe for electrospinning, and the solution was continuously pushed at a speed of 0.8 mL/h using a syringe pump. A tip portion of the syringe and a collector for collecting spun fibers were separated from each other at 15 cm intervals, and a high voltage of 16 kV was applied to spin the source solution due to a potential difference. Materials deposited on the collector were collected in an alumina (Al₂O₃) crucible and calcined for 3 hours at a temperature of about 700° C. in an air atmosphere to decompose all organic substances including polymer.

The calcined material was mixed with CaH₂ in the volume ratio of 1:1, reduced by heat-treating the mixture for 1 hour at a temperature of about 700° C. in an inert atmosphere, and washed with water using a mixed solution of ammonium chloride and methanol, so that magnetic nano-structure according to Example 1 was prepared by substituting with 3% of Cu in place of Co.

### Preparing a Magnetic Nano-Structure According to Example 2

The magnetic nano-structure was prepared according to Example 1, in which magnetic nano-structure according to Example 2 was prepared by substituting with 5% of Cu in place of Co by controlling the ratio of copper nitrate trihydrate (Cu(NO₃)₂3H₂O) in the source solution.

### Preparing a Magnetic Nano-Structure According to Example 3

The magnetic nano-structure was prepared according to Example 1, in which magnetic nano-structure according to Example 3 was prepared by substituting with 7% of Cu in place of Co by controlling the ratio of copper nitrate trihydrate (Cu(NO₃)₂3H₂O) in the source solution.

### Preparing a Magnetic Nano-Structure According to Example 4

The magnetic nano-structure was prepared according to Example 1, in which magnetic nano-structure according to Example 4 was prepared by substituting with 10% of Cu in place of Co by controlling the ratio of copper nitrate trihydrate (Cu(NO₃)₂3H₂O) in the source solution.

### Preparing a Magnetic Nano-Structure According to Example 5

The magnetic nano-structure was prepared according to Example 1, in which magnetic nano-structure according to Example 5 was prepared by substituting with 12% of Cu in place of Co by controlling the ratio of copper nitrate trihydrate (Cu(NO₃)₂3H₂O) in the source solution.

### Preparing a Magnetic Nano-Structure According to Example 6

The magnetic nano-structure was prepared according to Example 1, in which magnetic nano-structure according to Example 6 was prepared by substituting with 15% of Cu in place of Co by controlling the ratio of copper nitrate trihydrate (Cu(NO₃)₂3H₂O) in the source solution.

### Preparing a Magnetic Nano-Structure According to Example 7

The magnetic nano-structure was prepared according to Example 1, in which magnetic nano-structure according to Example 7 was prepared by substituting with 20% of Cu in place of Co by controlling the ratio of copper nitrate trihydrate (Cu(NO₃)₂3H₂O) in the source solution.

### Preparing a Magnetic Nano-Structure According to Comparative Example 1

The source solution was prepared by mixing samarium (III) nitrate hexahydrate (Sm(NO₃)₃6H₂O), cobalt (II) nitrate hexahydrate (Co(NO₃)₂6H₂O), and PVP with ultrapure water.

The prepared source solution is spun and reduced by the method according to Example 1, so that a magnetic nano-structure without including Cu according to Comparative Example was prepared.

The magnetic nano-structures according to the Examples and the Comparative Example will be summarized in the following <Table 1>, and the specific component rates of the magnetic nano-structures according to the Examples and Comparative Example will be summarized in the following <Table 2>.

TABLE 1

| | | Cu |
|---|---|---|
| | | substitution |
| | | amount in |
| Item | Configuration | place of Co |
| Example 1 | Sm—Co—Cu | 3% |
| Example 2 | Sm—Co—Cu | 5% |
| Example 3 | Sm—Co—Cu | 7% |
| Example 4 | Sm—Co—Cu | 10% |
| Example 5 | Sm—Co—Cu | 12% |
| Example 6 | Sm—Co—Cu | 15% |
| Example 7 | Sm—Co—Cu | 20% |
| Comparative | Sm—Co | 0% |
| Example 1 | | |

TABLE 2

| Item | Sm | Co | Cu |
|---|---|---|---|
| Example 1 | 16.7 wt % | 80.8 wt % | 2.5 wt % |
| Example 2 | 16.7 wt % | 79.2 wt % | 4.2 wt % |
| Example 3 | 16.7 wt % | 77.5 wt % | 5.8 wt % |
| Example 4 | 16.7 wt % | 75.0 wt % | 8.3 wt % |
| Example 5 | 16.7 wt % | 73.3 wt % | 10.0 wt % |
| Example 6 | 16.7 wt % | 70.8 wt % | 12.5 wt % |
| Example 7 | 16.7 wt % | 66.7 wt % | 16.7 wt % |
| Comparative | 16.7 wt % | 83.3 wt % | 0 wt % |
| Example 1 | | | |

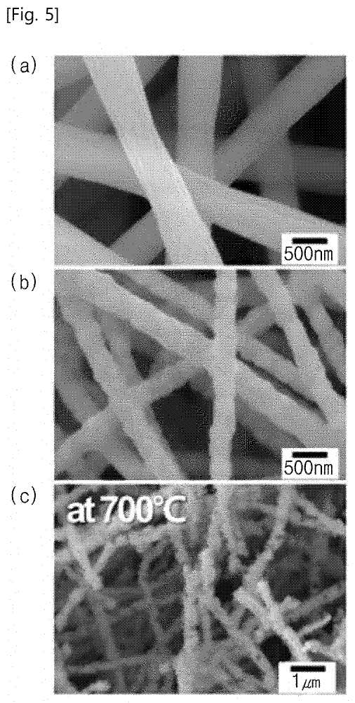

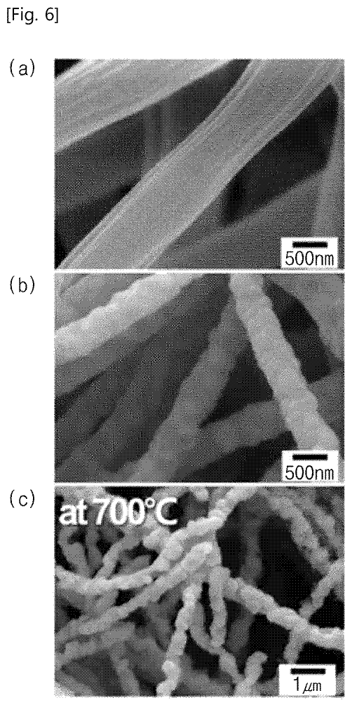

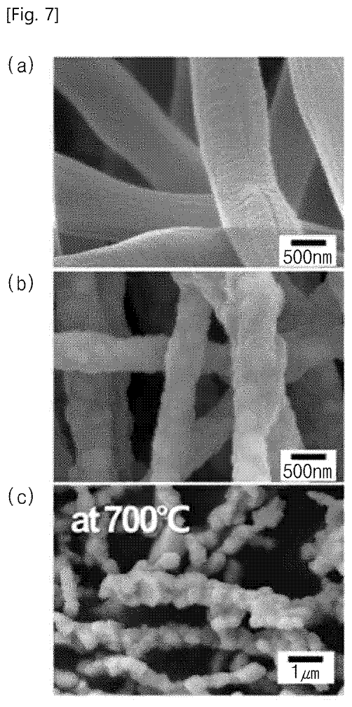

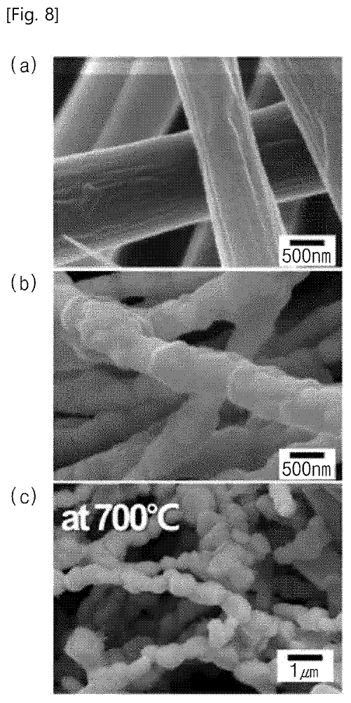

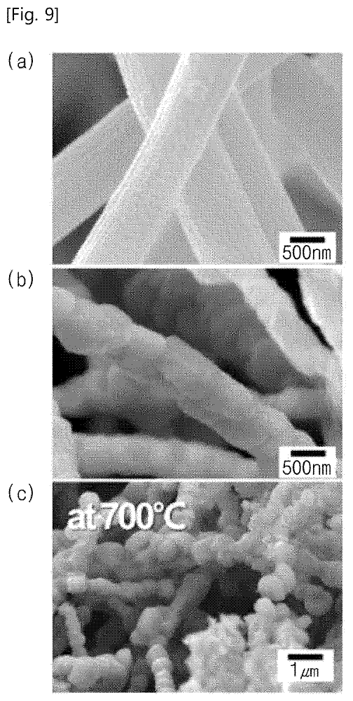

FIGS. 5 to 9 are photographs of magnetic nano-structures according to Examples and Comparative Example 1 of the present invention.

Referring to FIGS. 5 to 9, the magnetic nano-structures according to Comparative Example 1, Example 2, Example 4, Example 6, and Example 7 are photographed by a scanning electron microscope (SEM) and shown in FIGS. 5 to 9, respectively. In addition, during preparing each of the magnetic nano-structures, states immediately after electrospinning, sintered states, and reduced states are photographed and shown in (a) to (c).

As shown through FIGS. 5 to 9, it is confirmed that the magnetic nano-structures according to Comparative Example 1, Example 2, Example 4, Example 6, and Example 7 exhibit a crystal form through the electrospinning, sintering, and reduction processes. In addition, it is found that the grain size increases as the content of Cu increases, based on that the size of crystals included in each magnetic nano-structure gradually increases in the sequence of Comparative Example 1, Example 2, Example 4, Example 6, and Example 7. The grain size included in each magnetic nano-structure is summarized through the following <Table 3>, and the grain size is calculated through the following <Equation 1>.

TABLE 3

| Item | Grain size | |
|---|---|---|
| Comparative | 22.41 | nm |
| Example 1 | | |
| Example 2 | 26.10 | nm |
| Example 4 | 28.95 | nm |
| Example 6 | 31.61 | nm |
| Example 7 | 36.56 | nm |

D=kλ/β cos θ <Equation 1>

(D: grain size, k: shape constant (=0.9), λ: 0.1541 nm, β: FWHM (deg.), θ: peak angle (deg.))

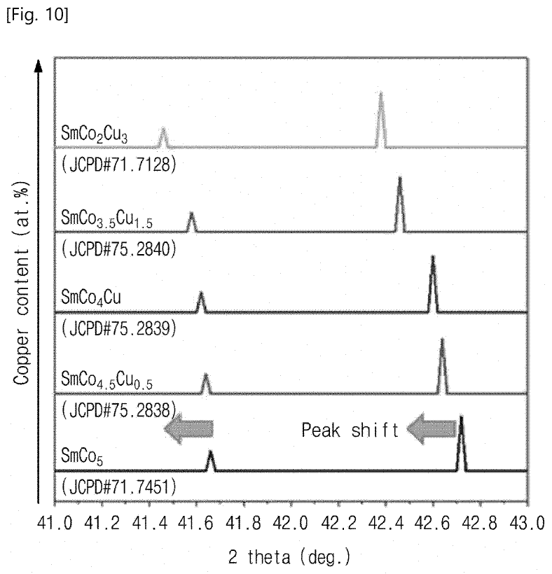

FIG. 10 is a graph showing X-ray diffraction analysis of an Sm—Co alloy composition and an Sm—Co—Cu alloy composition.

Referring to FIG. 10, the X-ray diffraction diffraction patterns are shown for each of the SmCo₅ alloy composition, SmCo_{4.5}Cuo_{0.5} alloy composition, SmCo₄Cu alloy composition, SmCo_{3.5}Cu_{1.5} alloy composition, and SmCo₂Cu₃ alloy composition.

As shown in FIG. 10, in the case of an alloy composition containing Cu it was found that the pattern was shifted to a low angle compared with the SmCo₅ alloy composition. In addition, it was found that the pattern was shifted to a low angle even within the Sm—Co—Cu alloy composition as the content of Cu increases. It can be determined that this is a phenomenon that occurs when the arrangement of atoms in the unit lattice represented by SmₓCo_{y}(x,y>0) is the same as the arrangement of atoms in the unit lattice represented by SmₓCo_{y}Cu_{z}(x,y,z>0), in which Cu is disposed in a position of Co. More specifically, when Cu is disposed at a position of Co in the unit lattice represented by SmₓCo_{y}, an atomic radius of Cu (1.57 Å) is smaller than an atomic radius of Co (1.67 Å), so that a stable SmCu₅ phase at an energy-level may be easily formed. Since the SmCu₅ phase has a larger lattice constant than that of the SmCo₅ phase, the phenomenon of shifting to a low angle is indicated in the X-ray diffraction diffraction pattern.

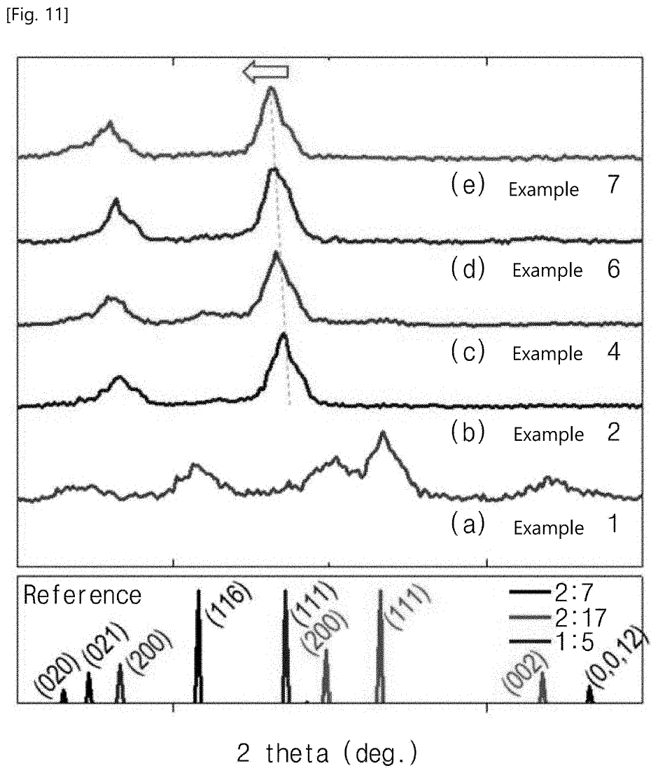

FIG. 11 is a graph showing X-ray diffraction analysis of magnetic nano-structures according to Examples and Comparative Example 1 of the present invention.

Referring to FIG. 11, the X-ray diffraction diffraction patterns are shown for each of the magnetic nano-structures according to Comparative Example 1, Example 2, Example 4, Example 6, and Example 7.

As shown in FIG. 11, it is confirmed that the magnetic nano-structures according to Example 2, Example 4, Example 6, and Example 7 that contain Cu had a pattern shifted to a low angle, compared with the magnetic nano-structure according to Comparative Example 1 that does not contain Cu. In addition, when magnetic nano-structures according to Example 2, Example 4, Example 6, and Example 7 are compared with each other, it is confirmed that the X-ray diffraction diffraction pattern is shifted to a low angle as the content of Cu increases.

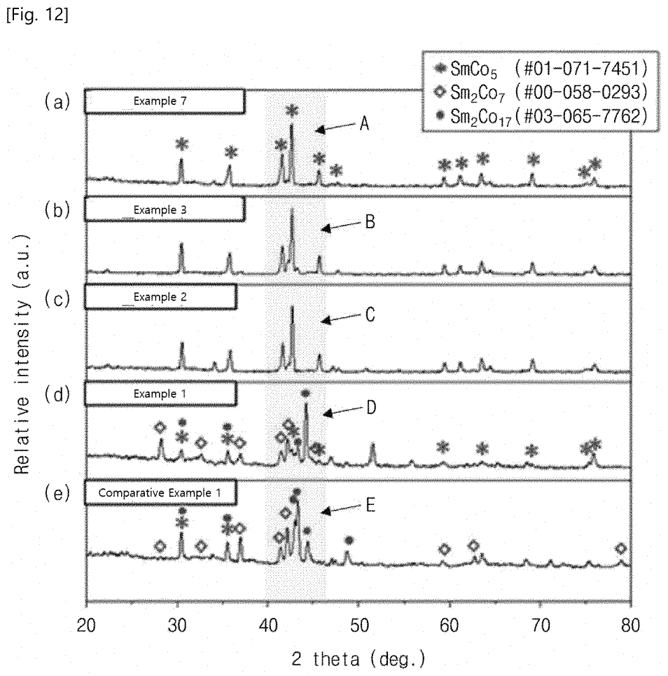

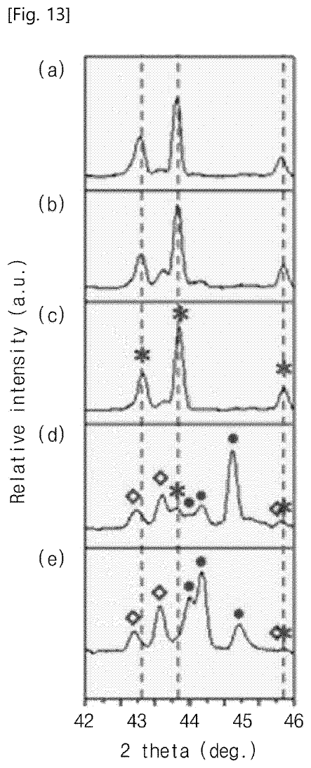

FIGS. 12 and 13 are X-ray diffraction analysis graphs for analyzing structures of magnetic nano-structures according to Examples and Comparative Example 1 of the present invention.

FIGS. 12 and 13 show the results of X-ray diffraction analysis of the magnetic nano-structures according to Example 7, Example 4, Example 2, Example 1, and Comparative Example. FIGS. 12(a) to 12(e) show the results of X-ray diffraction analysis of magnetic nano-structures according to Example 7, Example 4, Example 2, Example 1, and Comparative Example, respectively, and FIGS. 13(a) to 13(e) are graphs showing enlarged portions A to E indicated in FIGS. 12(a) to 12(e).

As shown in FIGS. 12(d) and 12(e) and FIGS. 13(d) and 13 (e), it is confirmed that the SmCo₅ phase, the Sm₂Co₇ phase, and the Sm₂Co₁₇ phase are mixed in the magnetic nano-structures according to Example 1 and Comparative Example 1.

In contrast, as shown in FIGS. 12(b) and 12(c) and FIGS. 13(b) and 13(c), it is confirmed that the magnetic nano-structures according to Example 2 and Example 4 exhibit an SmCo₅ single phase. In addition, as shown in FIGS. 12(a) and 13(a), it is confirmed that the magnetic nano-structure according to Example 7 exhibits a state in which the SmCo₅ phase and the SmCu₅ phase are mixed with each other.

In other words, it can be seen that, in the magnetic nano-structure according to the Example, at least 5% of the substitution amount of Cu is required in place of the transition metal to obtain high coercive force through an anisotropic ReM₅ single phase.

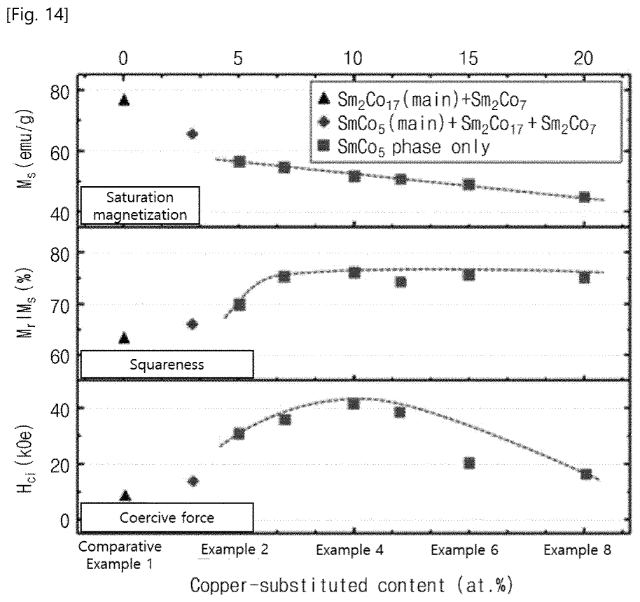

FIG. 14 is a graph showing the magnetization characteristics of magnetic nano-structures according to Examples and Comparative Example of the present invention.

Referring to FIG. 14, the saturation magnetization, rectangularity ratio, and coercive force of the magnetic nano-structures according to Comparative Example 1 and Examples 1 to 7 are measured and shown. The magnetic property values and the crystal phase structure of each magnetic nano-structure measured through FIG. 14 are summarized through the following <Table 4>.

TABLE 4

| | Crystalline | Saturation | Remanence | Rectangularity | Coercive |
|---|---|---|---|---|---|
| | structure | magnetization | magnetization | ratio | force |
| Item | (M:Co + Cu) | (emu/g) | (emu/g) | (%) | (Oe) |
| Comparative | Sm₂Co₁₇, | 75.716 | 45.063 | 59.516 | 7570.8 |
| Example 1 | Sm₂Co₇ | | | | |
| Example 1 | SmM₅Sm₂M₁₇, | 65.416 | 43.310 | 66.207 | 13195.9 |
| | Sm₂M₇ | | | | |
| Example 2 | SmM₅ | 55.927 | 39.074 | 69.867 | 29707.9 |
| Example 3 | SmM₅ | 54.365 | 41.078 | 75.559 | 35062.5 |
| Example 4 | SmM₅ | 51.652 | 39.433 | 76.276 | 40737.9 |
| Example 5 | SmM₅ | 50.774 | 37.840 | 74.525 | 37775.8 |
| Example 6 | SmM₅ | 48.888 | 36.972 | 75.626 | 18936.5 |
| Example 7 | SmM₅ | 45.267 | 34.132 | 75.403 | 16469.7 |

As shown in FIG. 14 and <Table 4>, it is confirmed that the saturation magnetization and remanence magnetization of the magnetic nano-structures according to Examples 1 to 7 are low, compared to the magnetic nano-structure according to Comparative Example 1. In contrast, it is confirmed that the coercive forces of the magnetic nano-structures according to Examples 1 to 7 are high, compared to the magnetic nano-structure according to Comparative Example 1.

Meanwhile, when comparing the magnetic nano-structures according to Examples 1 to 7 to each other, it is confirmed that the saturation magnetization and remanence magnetization decreases as the Cu content increases. In addition, it can be seen that the magnetic structures according to Examples 1 to 4 have the increasing coercive force as the Cu content increases, but the magnetic structures according to Examples 5 to 7 have the decreasing coercive force as the Cu content increases.

As a result, it can be seen that, when the substitution amount of Cu in place of Co is controlled to be more than 7% and less than 12%, the saturation magnetization and remanence magnetization slightly decrease, but the magnetic nano-structure having improved magnetic properties are provided through the significant improvement of the coercive force.

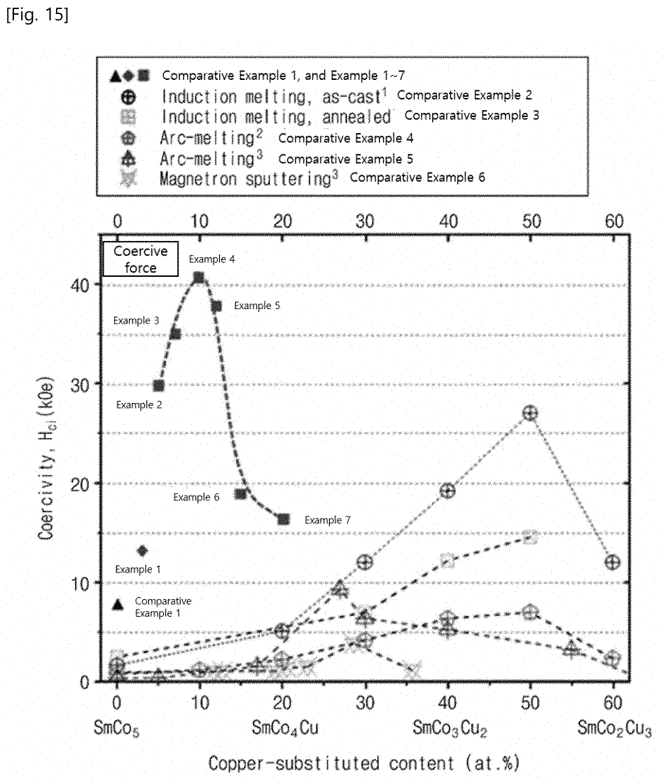

FIG. 15 is a graph for comparing coercive forces of the magnetic nano-structures according to Examples and Comparative Examples of the present invention.

Referring to FIG. 15, the magnetic nano-structures according to Examples 1 to 7 and the magnetic nano-structures according to Comparative Examples 1 to 6 are prepared and the coercive forces (coercivity, Hci, kOe) are measured and shown, respectively. The magnetic nano-structures according to Comparative Examples 2 to 6 will be summarized in the following <Table 5>.

TABLE 5

| Item | Preparing method | Structure |
|---|---|---|
| Comparative | Induction melting, | SmCo₅₋ₓCuₓ |
| Example 2 | As-cast | alloys |
| Comparative | Induction melting, | SmCo₅₋ₓCuₓ |
| Example 3 | Annealed | alloys |
| Comparative | Arc-melting | Alloys in which |
| Example 4 | | Sm—Co—Cu and |
| | | Pr—Co—Cu are |
| | | mixed in the |
| | | ratio of 1:5 |
| Comparative | Arc-melting | Sm (Co, Cu)₅ |
| Example 5 | | alloys |
| Comparative | Magnetron | SmCo₅ |
| Example 6 | sputtering | |

As shown in FIG. 15, it is confirmed that the magnetic nano-structures according to the Examples have the coercive forces significantly higher than those of the magnetic nano-structures according to the comparative examples. In addition, it is found that the magnetic nano-structure according to Example 4 has the highest coercive force among the magnetic nano-structures according to the Examples.

Although the present invention has been described in detail with reference to the preferred embodiments, the present invention is not limited to the specific embodiments and shall be interpreted by the following claims. In addition, it will be apparent that a person having ordinary skill in the art may carry out various deformations and modifications for the embodiments described as above within the scope without departing from the present invention.

### INDUSTRIAL APPLICABILITY

The magnetic nano-structure containing copper (Cu) according to the embodiments of the present invention may be applicable to various industrial fields for permanent magnets, electric motors, sensors, and the like.

1. A method for preparing a magnetic nano-structure, the method comprising:
preparing a source solution containing a first precursor including a rare-earth element, a second precursor including a transition metal element, and a third precursor including Cu;
forming a preliminary magnetic nano-structure containing a rare-earth oxide, a transition metal oxide, and Cu oxide by electrospinning the source solution; and
manufacturing a magnetic nano-structure containing an alloy composition of the rare-earth element, the transition metal element, and the Cu by reducing the preliminary magnetic wire.

2. The method of claim 1, wherein Cu in the source solution has a molar ration more than 5.8 at % and less than 10.9 at %.

3. The method of claim 1, wherein the forming of the magnetic nano-structure includes:
mixing the preliminary magnetic nano-structure with a reducing agent;
heat-treating the preliminary magnetic nano-structure mixed with the reducing agent; and
washing the heat-treated preliminary magnetic nano-structure by using a cleaning solution.

4. The method of claim 1, wherein the reducing agent includes calcium (Ca).

5. The method of claim 1, wherein a coercive force is controlled by controlling a content of Cu.

6. A magnetic nano-structure comprising:
an alloy composition of a rare-earth element, a transition metal element, and Cu, wherein
Cu in the alloy composition has a content more than 5.8 wt % and less than 10.0 wt %.

7. The magnetic nano-structure of claim 6, wherein the alloy composition is composed of a unit lattice (unit cell) represented by ReM₅ (Re: rare-earth element, M: at least one of a transition metal element or Cu).

8. The magnetic nano-structure of claim 7, wherein a crystal structure of ReM₅ includes a hexagonal system.

9. The magnetic nano-structure of claim 7, wherein Cu is disposed in at least one of 2c and 2g sites in the unit lattice.

10. The magnetic nano-structure of claim 6, wherein the rare-earth element includes at least one of La, Ce, Pr, Nd, Sm, or Gd.

11. The magnetic nano-structure of claim 6, wherein the transition metal element includes at least one of Co or Ni.

12. The magnetic nano-structure of claim 6, wherein the magnetic nano-structure has a single crystal and an anisotropic property.

13. The magnetic nano-structure of claim 6, wherein, in the alloy composition, the rare-earth element has a content of 16.7 wt %, and the transition metal element has a content more than 73.2 wt % and less than 77.5 wt %.

14. A magnetic nano-structure comprising:
an alloy composition composed of a unit lattice represented by Formula 1.
ReTMₓCu₅₋ₓ <Formula 1>
(Re: rare-earth element, TM: transition metal element)

15. The magnetic nano-structure of claim 14, wherein the magnetic nano-structure comprises:
an alloy composition having a unit lattice represented by <Formula 1> after more than 7% and less than 12% of the TM is substituted with the Cu in the alloy composition including a unit lattice represented by Formula 2.
ReTM₅ <Formula 2>
(Re: rare-earth element, TM: transition metal element).

16. The magnetic nano-structure of claim 14, wherein the magnetic nano-structure has a coercive force of 40000 Oe or more.
